(19) United States
(12) Patent Application Publication
(10) Pub. No.: US 2015/0063920 A1
(43) Pub. Date: Mar. 5, 2015

(54) METHODS AND APPARATUS FOR ARRESTING FAILURES IN SUBMERGED PIPELINES

(71) Applicant: Halliburton Energy Services, Inc., Houston, TX (US)

(72) Inventors: Steven Ray Lovett, Marlow, OK (US); Aimee Kathleen Greening, Duncan, OK (US)

(73) Assignee: Halliburton Energy Services, Inc., Houston, TX (US)

(21) Appl. No.: 14/014,719

(22) Filed: Aug. 30, 2013

(51) Int. Cl. F16L 1/26

(52) U.S. Cl. CPC F16L 1/26
USPC 405/184.2

(57) ABSTRACT

A wet buckle packer includes a first disk and a second disk offset from and axially aligned with the first disk. A mandrel, elastomeric expansion boot, and brake are disposed between and axially aligned with the first and second disks. The mandrel includes a tapered outer surface and the brake includes a tapered inner surface abutting the tapered inner surface of the mandrel. The first disk is configured to move axially toward the second disk from a first position to a second position. In the second position, the first disk causes: the expansion boot to compress axially and expand radially into engagement with an inner surface of the pipeline; and the tapered inner surface of the brake to move axially along the tapered outer surface of the stationary mandrel to cause the brake to move radially outward into engagement with the inner surface of the pipeline.

### BACKGROUND

This disclosure relates generally to offshore pipelines, and more specifically to methods and apparatus for responding to failures in offshore submerged pipelines.

In offshore pipeline installations, as the pipeline is laid on the sea floor the pipeline is subjected to significant forces and moments that can compromise the integrity of the pipeline and, in some cases, cause failures. In the event the submerged pipeline is compromised to the point of failure, water rushes into the pipeline. Such failures are commonly referred to as wet buckles. Once a wet buckle occurs the flooded pipeline is too heavy to retrieve for repair and re-installation.

Companies that lay the pipeline keep a fleet of compressor ships on standby while the pipeline is being laid on the sea floor in case of a failure like a wet buckle. The compressor ships are present to pump the water out of the pipeline to facilitate repair of the buckled section, by allowing the pipeline to be pulled back to the surface, to the pipelay vessel, for removal of the damaged section. After the water has been removed, sections of the damaged pipeline can be retrieved and brought to the surface and the pipelay vessel can continue laying pipe onto the sea floor.

Pipeline failures like wet buckles are relatively rare. As such, during installation, the fleet of compressor ships hired by the pipeline installation company is generally inactive and serves no function for the installation process unless the rare failure occurs. The cost of the compressor ships and the associated service the ships and crew provide can reach the millions of dollars.

### BRIEF DESCRIPTION OF DRAWINGS

FIG. 1 schematically depicts a submerged pipeline installation system including wet buckle packers in accordance with this disclosure.

FIG. 2 depicts an elevation view of an example wet buckle packer in accordance with this disclosure.

FIG. 3A depicts a section view of the example packer of FIG. 2 in an unengaged state within a pipeline.

FIG. 3B depicts a section view of the example packer of FIG. 2 in an engaged state within a pipeline.

FIG. 4 depicts an example method of arresting a failure in a submerged pipeline.

### DETAILED DESCRIPTION

In view of the foregoing costs and other inefficiencies associated with recovering from an offshore pipeline failure, examples according to this disclosure are directed to methods and apparatus for automatically responding to water invasion into the inner diameter of pipe in an offshore pipeline and rapidly deploying a sealing system that will prevent or inhibit the laid pipeline from being flooded with water.

A packer apparatus in accordance with this disclosure is configured to be arranged within and arrest a failure of a submerged pipeline. In one example, the packer includes a first disk and a second disk offset from and axially aligned with the first disk. A mandrel, elastomeric expansion boot, and brake are disposed between and axially aligned with the first and second disks. The mandrel includes a tapered outer surface and the brake includes a tapered inner surface abutting the tapered inner surface of the mandrel. The first disk is configured to move axially toward the second disk from a first position to a second position. In the second position, the first disk causes: the expansion boot to compress axially and expand radially into engagement with an inner surface of the pipeline; and the tapered inner surface of the brake to move axially along the tapered outer surface of the stationary mandrel to cause the brake to move radially outward into engagement with the inner surface of the pipeline.

The expansion boot of the packer apparatus can be a first elastomeric expansion boot disposed between the first disk and a first end of the brake. The packer apparatus can also include a second elastomeric expansion boot disposed between the second disk and a second end of the brake. In the second position, the second expansion boot is compressed axially between the second end of the brake and the second disk and is expanded radially into engagement with an inner surface of the pipeline.

In the following examples, the apparatus for arresting pipeline wet buckles (and other pipeline failures) is referred to as a wet buckle packer. However, the apparatus could also be referred to as a plug, a shutoff pig, a baffle, or other terms connoting a device that restricts, and ideally prevents fluid flow through an annular pipeline.

Wet buckle packers in accordance with this disclosure provide a number of functions once actuated. Packer apparatus in accordance with this disclosure are sometimes referred to as configured to arrest a failure like a wet buckle in a submerged pipeline. Arresting a failure in a pipeline includes a number of different functions. In both dry and wet buckles, for example, the pipeline failure can include a structural failure including a buckle that causes the pipeline to at least partially collapse on itself. The structural buckle can run along the length of the pipeline unless it is arrested. In wet buckles, water also invades the inner diameter of the pipe causing the pipeline to become flooded. Packer apparatus in accordance with this disclosure can function to arrest both a structural buckle in a submerged pipeline, whether from a dry or wet buckle, and deploy a sealing system that will prevent or inhibit the laid pipeline from being flooded with water in the event of a wet buckle. Additionally, the packer deploys a braking mechanism to prevent or inhibit the packer from moving within the pipeline under the significant pressures introduced by the sea (or fresh) water entering the pipe from the wet buckle.

As noted above, wet buckle packers in accordance with this disclosure are configured to be automatically actuated to seal the pipeline from ingress of water. The mechanisms for sealing and braking employed in a wet buckle packer can be actuated in a variety of ways. For example, electrical, hydraulic, or pneumatic supply lines can be run from the pipelay vessel on the surface to the packer. The wet buckle packer could also include a power source, e.g., a battery that could be used to actuate the seal and brake mechanisms. The packers or the systems in which they are employed can be configured to be actuated automatically using a variety of different sensors configured to detect water invasion into the pipeline.

Wet buckle packers in accordance with this disclosure provide a new approach to seal and anchor a packer-type plug in place within a pipeline in the event of a wet buckle. The packers are designed to provide increased durability and to include component parts that protect against external variances. Example wet buckle packers can provide a number of advantages including, e.g., removing the high cost of air compressor standby in submerged pipeline installations and providing a simple and cost effective device for arresting failures in the pipeline.

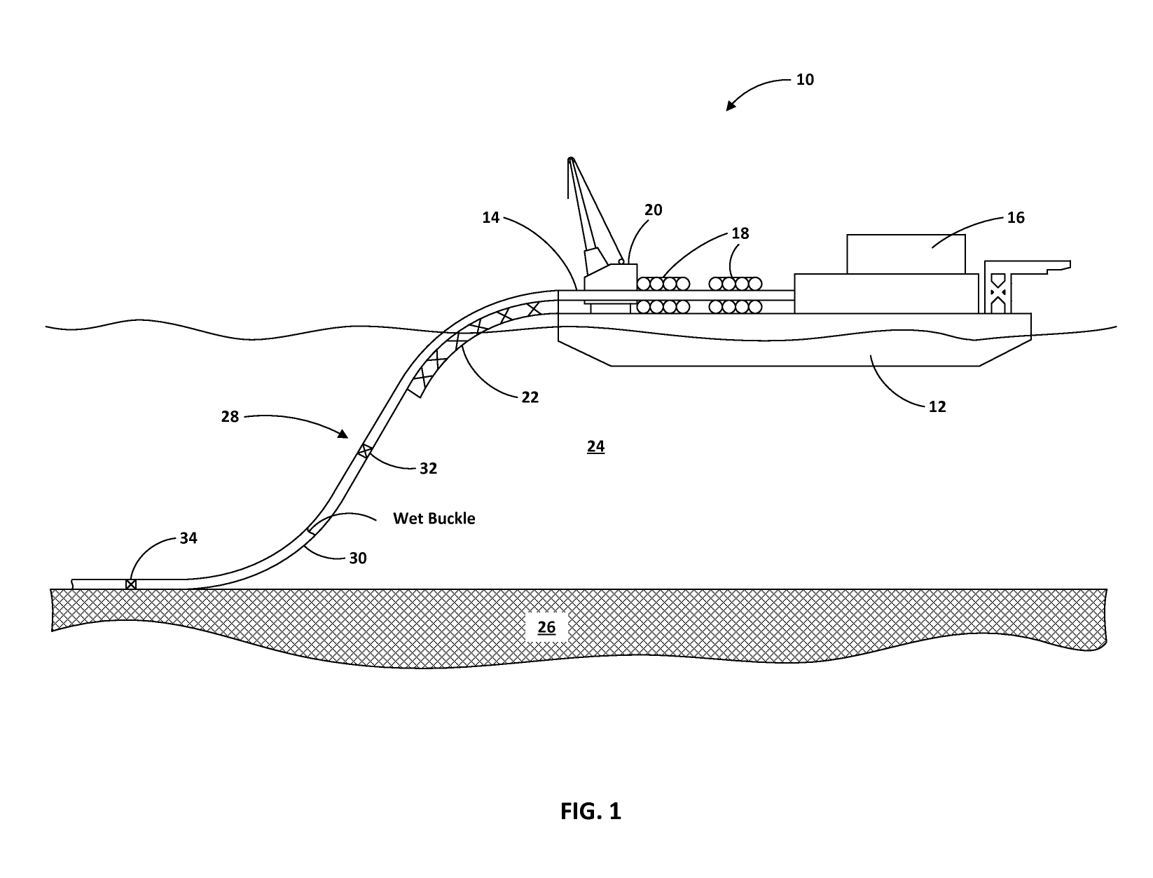

FIG. 1 depicts a submerged pipeline installation system 10. Offshore submerged pipelines can be installed in a number of ways. In general, individual pipes are transported by a cargo ship to a pipelay vessel at the pipeline installation location. The individual pipes are processed and connected to one another on the pipelay vessel and laid onto the sea floor. The pipelay vessel progressively welds individual pipes or welded pipe sections to one another to assemble the pipeline. As the pipeline is assembled the pipelay vessel moves across the surface of the water and the assembled pipeline is pulled off of the ship by the weight of the pipeline. As the pipeline is progressively pulled off of the back of the pipelay vessel it descends to the sea floor.

Two methods that are employed to install submerged pipelines are the “J” lay and the “S” lay. The moniker of each method represents the shape of the pipeline as it is pulled off of the pipelay vessel onto the sea floor. In a “J” lay, the pipeline is pulled off of the pipelay vessel substantially vertically to near the sea floor, where the pipeline bends to run horizontally along the floor. In an “S” lay, the pipeline is pulled off of the pipelay vessel substantially horizontally, bends vertically down toward the sea floor and then bends back horizontally away from the vessel to run along the sea floor. Although the following examples are described in the context of an “S” lay installation, wet buckle packers in accordance with this disclosure can also be employed in a “J” lay installation system or other pipeline installation methods not covered here.

FIG. 1 depicts a submerged pipeline installation system 10 for an “S” lay installation. In FIG. 1, system 10 includes pipelay vessel 12 and pipeline 14. Pipelay vessel 12 includes production factory 16, tensioners 18, crane 20, and stinger 22. As described in more detail below, after individual pipes are transported to and loaded on pipelay vessel 12, the pipes are conveyed into production factory 16. Production factory 16 includes a variety of processing stations for preparing pipes and coupling individual pipes into pipe sections and ultimately assembling pipeline 14, as will be known to persons skilled in the art.

Pipelay vessel 12 is shown floating in a body of water 24. Pipelay vessel 12 utilizes crane 20 to perform heavy lifting operations, including loading pipes from a cargo ship onto the vessel. In general, individual pipes on board pipelay vessel 12 are placed on an assembly line within production factory 16 and joints of the pipes are welded into pipeline 14. Pipeline 14 is held in tension between sea floor 26 and pipelay vessel 12 by pipeline tensioners 18 as the pipeline is lowered. As pipelay vessel 12 moves forward by pulling on a mooring system off of the bow, pipeline 14 is lowered from pipelay vessel 12 over stinger 22. Stinger 22 is attached to and extends from the stern of pipelay vessel 12, and provides support for pipeline 14 as it leaves pipelay vessel 12.

In practice, a cargo ship transports pipe sections (sometimes referred to as stands) to pipelay vessel 12. Crane 20 moves pipe sections from the cargo ship to pipelay vessel 12 onto cradles that form a conveyor system for moving pipe into production factory 16. Within production factory 16, a number of different operations are carried out to prepare and join pipe sections. For example, the pipe ends are beveled (and bevels are deburred). The pipe ends are preheated within production factory 16 and moved through a number of welding stations to join different sections with weld beads applied both to the outer and inner diameters of the sections at the joints. In some cases, a final welding station within production factory 16 applies a welded cap to the joints of pipe sections.

The joints of the welded pipe sections can also be tested within production factory 16. For example, the welded joints can pass through ultrasonic testing stations that apply water to the joints as the medium to transmit the ultrasonic signals. The ultrasonic signals can be processed by a computing system and graphically displayed for inspection by an operator.

After testing, the joints of the welded pipe sections can be grit blasted and a field joint coating can be applied. In some installation systems, each individual pipe is subjected to this process as it is welded to pipeline 14. In other cases, multiple pipes, e.g. two pipes in a double stand facility, are first welded together and then welded to the pipeline in the firing line onboard pipelay vessel 12. At any rate, the assembled pipeline 14 is ultimately conveyed through tensioners 18 and over stinger 22 to be dropped off of the stern of pipelay vessel 12 to sea floor 26.

As pipeline 14 is laid on sea floor 26, suspended pipe span 28 forms a shallow “S” shape between sea floor 26 and pipelay vessel 12. The “S” shape of suspended pipe 28 is sometimes referred to as the S-curve. Second curve 30 or the tail of the S-curve just before suspended pipe span 28 meets sea floor 26 is sometimes referred as the “sagbend.” The S-curve of pipeline 14 is controlled by stinger 22 and pipeline tensioners 18. Increases in the curvature of pipeline 14 cause increases in the bending moment on the pipeline, and, as a result, higher stresses. High stresses on pipeline 14 and, in particular, on suspended pipe span 28 can result in buckling of the pipeline 14. For example, a loss of tension in pipeline 14 during the pipe lay will normally cause pipeline 14 to buckle at a point along the suspended pipe span 28. A buckle in pipeline 14 is called a wet buckle if pipeline 14 has cracked or becomes damaged in a manner such that water is allowed to enter the inner diameter of the pipeline. The influx of water into the pipeline 14 greatly increases the weight of suspended pipe span 28 such that the pipe can become over stressed at a location along suspended pipe span 28, generally near stinger 22. In such circumstances, flooded pipeline 14 can break and drop from pipelay vessel 12 to sea floor 26. Regardless of whether pipeline 14 breaks in the event of a wet buckle, the increased weight can prevent recovery of and repair to pipeline 14 before the water is pumped out of the pipeline.

Examples according to this disclosure are directed to a wet buckle packer that can be deployed within the inner diameter of pipeline 14 as it is laid on sea floor 26. In FIG. 1, installation system 10 includes two wet buckle packers 32 and 34 deployed within pipeline 14. Packer 32 is deployed along suspended pipe span 28, while packer 34 is deployed downpipe where pipeline 14 meets sea floor 26. Wet buckle packers 32 and 34 are deployed within pipeline 14 with a hoist line or cable (not shown). In cases where multiple wet buckle packers are deployed in series, a hoist line may be coupled between the packers. In the example of FIG. 1, a hoist line may be coupled to a hoist on pipelay vessel 12 to packer 32 and another line can be coupled between packers 32 and 34. As will be apparent to persons skilled in the art, substantial benefits can be realized through an alternative configuration using only a single wet buckle packer, located generally in the position of depicted packer 34, positioned to prevent substantial inflow of water into the already-laid portion of pipeline 14 on sea floor 26.

Wet buckle packers 32 and 34 are configured to automatically respond to water invasion into the inner diameter of pipeline 14 and rapidly deploy a sealing system that will prevent the laid pipeline and pipeline above packer 32 from being flooded with sea water. For example, wet buckle packers 32 and 34 seal the inner diameter of pipeline 14 to prevent or significantly inhibit water from flooding the submerged pipeline. Additionally, wet buckle packers 32 and 34 deploy a braking mechanism to prevent or inhibit the packers from moving within pipeline 14 as a result of the pressures introduced by the sea water entering the pipe from the wet buckle.

In some cases one or more “piggy-back” lines may be laid from pipelay vessel 12 along with main pipeline 14. Piggy-back lines are generally constructed from smaller diameter pipes that are assembled in a similar manner as described above with reference to pipeline 14. The piggy-back lines are assembled in parallel with and are then coupled to pipeline 14, e.g., with a sleeve connected to the top of the main pipeline in which the piggy-back lines are received.

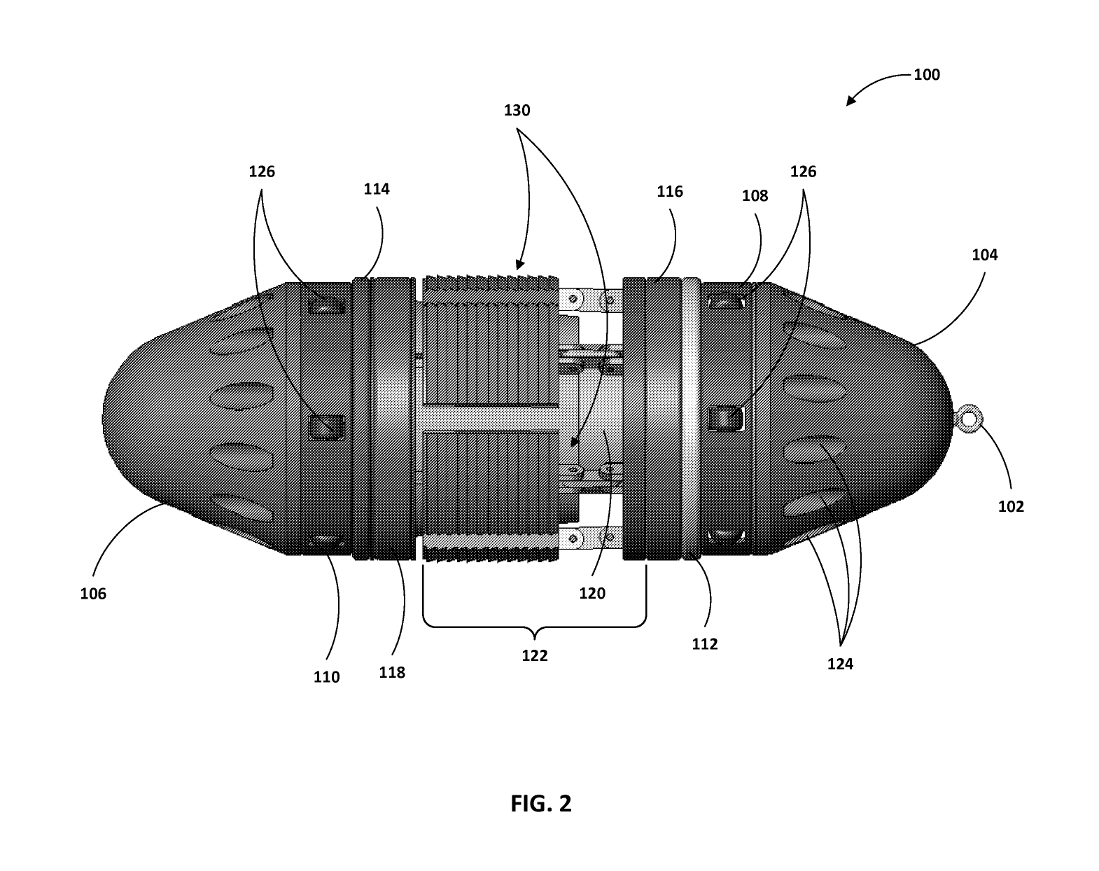

FIG. 2 depicts example wet buckle packer 100. Packer 100 includes a hoist ring 102, end caps 104 and 106, bearings 108 and 110, first and second disks 112 and 114, expansion boots 116 and 118, a mandrel 120, and brake assembly 122. Packer 100 is configured such that generally the same components are arranged axially on either end of mandrel 120 and brake assembly 122, which are disposed generally in the middle of packer 100. End caps 104 and 106 generally define either end of packer 100. Caps 104 and 106, bearings 108 and 110, and first and second disks 112 and 114 can be connected to one another via fasteners (not shown) received within apertures 124, or another appropriate mechanism. Second disk 114 and mandrel 120 can also be connected via fasteners. In another example, second disk 114 and mandrel 120 are welded or otherwise adhered to one another. In another example, second disk 114 and mandrel 120 are fabricated as a single, integral component. Expansion boot 116 is disposed between first disk 112 and one end of brake assembly 122. Expansion boot 118 is disposed between second disk 114 and the opposite end of brake assembly 122. Packer is coupled to hoist line 112 by hoist ring 102, which is connected to cap 104.

Packer 100 is configured to be connected to hoist line 112 and deployed from a pipelay vessel within pipeline. Packer 100 can be lowered into an already submerged pipeline or can be lowered along with a particular section of the pipeline as it is dropped to the sea floor. Bearings 108 and 110 each include a number of freely rotating wheels 126 distributed around the outer circumference of the bearings. Wheels 126 facilitate travel of packer 100 within the pipeline as packer 100 is lowered from the pipelay vessel and as otherwise may be needed during the pipe laying process.

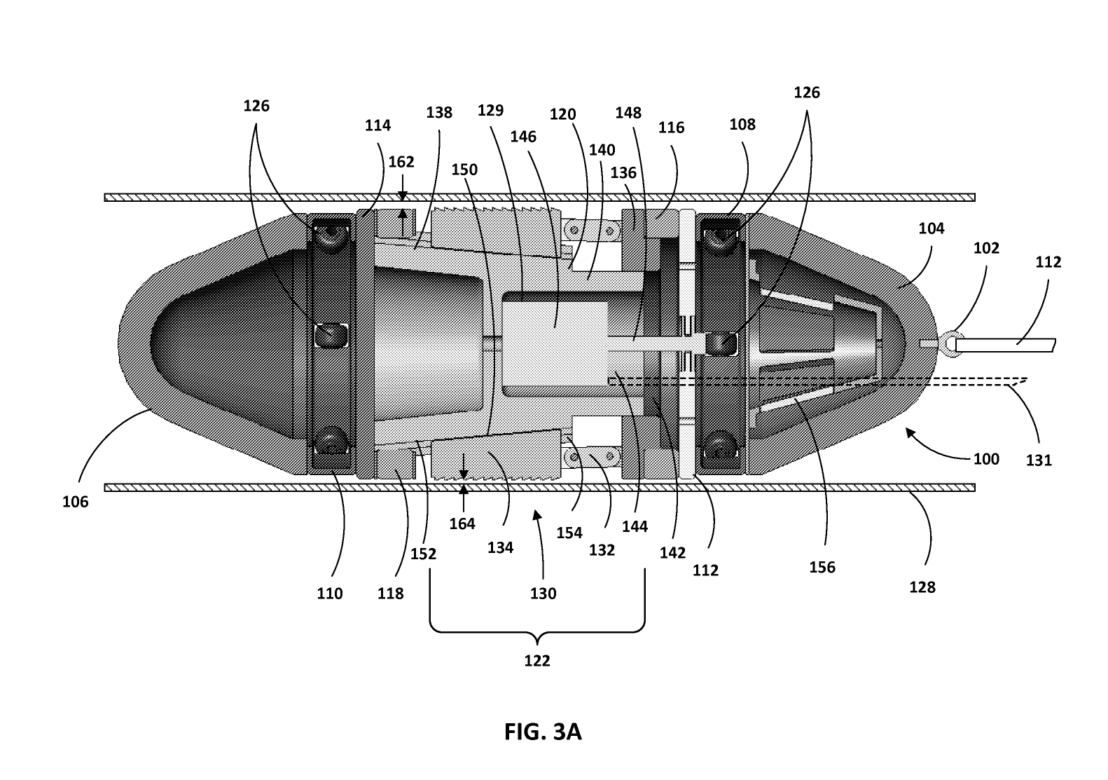

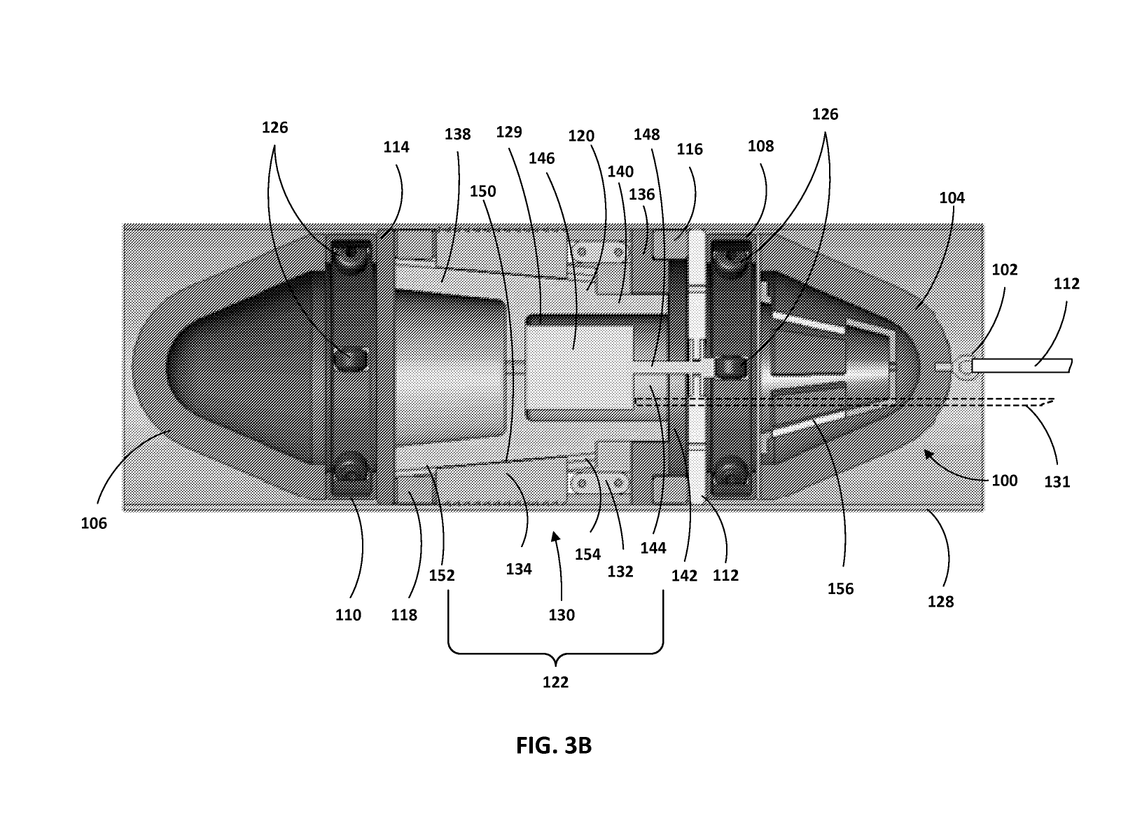

Packer 100 can be deployed at a number of locations within the submerged pipeline to arrest pipeline failures like wet buckles. For example, packer 100 can be deployed along a suspended pipe span of the pipeline or further downpipe where the pipeline meets the sea floor. Wet buckle packer 100 is configured to automatically respond to water invasion into the inner diameter of the pipeline and rapidly deploy a sealing system that will prevent the laid pipeline from being flooded with sea water, which is described in more detail with reference to FIGS. 3A and 3B.

Hoist line 112 extends from hoist ring 102 up to, for example, a hoist machine on a pipelay vessel. In some examples, packer 100 can include hoist rings on both ends of the device to deploy multiple packers within a pipeline in spaced, series relation within the pipeline. Thus, in the example of FIG. 1, one packer could be deployed within suspended pipe span 28 closer to the surface than the likely location of the wet buckle in the sagbend of the “S” curve and another packer could be deployed within pipeline 14 on the other side of the possible wet buckle location, e.g., somewhere along sea floor 26.

FIGS. 3A and 3B depict section views of wet buckle packer 100 within pipeline 128. In FIG. 3A, packer 100 is unengaged with pipeline 128. In FIG. 3B, packer 100 is engaged with pipeline 128 to substantially seal pipeline 128 from water invasion. As illustrated in the section views of FIGS. 3A and 3B, packer 100 includes an actuator 129 in addition to hoist ring 102, end caps 104 and 106, bearings 108 and 110, first and second disks 112 and 114, expansion boots 116 and 118, mandrel 120, and brake assembly 122. Actuator 129 is connected to first disk 112 and mandrel 120. Supply line 131 is coupled to actuator 129. Supply line 131 is schematically illustrated in FIGS. 3A and 3B in a dashed line format.

Caps 104 and 106, bearings 108 and 110, and first and second disks 112 and 114 can be connected to one another in a variety of ways. In the example of FIGS. 3A and 3B, caps 104 and 106, bearings 108 and 110, and first and second disks 112 and 114 are connected to one another via fasteners (not shown) received within apertures 124 (see FIG. 2). In another example, however, caps 104 and 106, bearings 108 and 110, and first and second disks 112 and 114 could be welded to one another.

First disk 112 is configured to move axially toward second disk 114. As first disk 112 moves axially, disk 112 pushes expansion boot 116 and brake assembly 122, which eventually engages expansion boot 118. Brake assembly 122 includes a number of brake mechanisms 130 that are distributed at different angularly disposed, circumferential positions around a longitudinal axis of packer 100. In the example of FIGS. 2-3B, brake assembly 122 includes six brake mechanisms 130. However, in other examples, brake assembly 122 could include more or fewer individual mechanisms.

Each brake mechanism 130 includes a linkage 132 and a pad 134. All of the linkages 132 of brake mechanisms 130 are pivotally connected to brake plate 136 at one end of the linkage. Each linkage 132 is pivotally connected to a respective pad 134 at the other end of the linkage.

Mandrel 120 includes a conical portion 138 and a cylindrical portion 140. Brake plate 136 includes a central bore 142 in which cylindrical portion 140 of mandrel 120 is received. Brake plate 136 is configured to move axially relative to mandrel 120 guided by bore 142 sliding along cylindrical portion 140.

Actuator 129 is connected to first disk 112 and mandrel 120 and is disposed within a bore 144 of cylindrical portion 140 mandrel 120. Actuator 129 is depicted schematically in FIGS. 3A and 3B, but generally includes housing 146 and shaft 148 movably connected to housing 146. Shaft 148 is configured to slide in and out of housing 146. Housing 146 of actuator 129 is arranged within bore 144 of mandrel 120. Shaft 148 extends axially from housing 146 through a hole in first disk 112. The distal end of shaft 148 is connected to first disk 112. In one example, a nut and two washers are employed to fix the distal end of shaft 148 to first disk 112. However, shaft 148 could also be attached by other mechanisms, e.g., welded to first disk 112. In another example, first disk 112 could be fabricated with an integral shaft protruding axially toward mandrel 120 and housing 146 of actuator 129.

Actuator 129 can be a variety of mechanical and electromechanical devices that are configured to be actuated to cause shaft 148 to move axially relative to housing 146. For example, actuator 129 can include a pneumatically or hydraulically actuated piston that drives shaft 148 with air or a hydraulic fluid supplied by supply line 131. In another example, actuator 129 includes an electrically activated solenoid that drives shaft 148. In another example, actuator 129 includes an electromagnetic piston that drives shaft 148 based on controlled electricity transmitted to packer 100 via supply line 131. In another example, actuator 129 includes an electric motor and screwjack, which can drive shaft 148 using electricity transmitted to packer 100 via supply line 131. In some cases, actuator 129 can be powered by a power source like a battery deployed with packer 100.

Actuator 129 is configured to cause the end of shaft 148 coupled to first disk 112 to move axially relative to housing 146. As the distal end of shaft 148 changes axial position with respect to housing 146, first disk 112 is drawn toward second disk 114, which, in turn, causes first disk 112 to drive expansion boot 116, brake plate 136, and pads 134 toward second disk 114.

In the example of packer 100, expansion boots 116 and 118 are annular elastomeric boots. Expansion boot 116 is arranged between first disk 112 and brake plate 136. Expansion boot 118 is arranged between second disk 114 and one end of brake pads 134. As first disk 112 moves axially toward second disk 114, brake pads 134 move closer to and eventually engage expansion boot 118. Once brake pads 134 engage expansion boot 118, both expansion boots 116 and 118 are compressed axially. Expansion boot 116 is compressed axially between first disk 112 and brake plate 136 and expansion boot 118 is compressed between brake pads 134 and second disk 114. As expansion boot 116 is compressed axially, boot 116 also radially expands into engagement with an inner surface of pipeline 128. Similarly, as expansion boot 118 is compressed axially, boot 118 also radially expands into engagement with the inner surface of pipeline 128.

Each brake pad 134 of each mechanism 130 includes a tapered inner surface 150. Tapered inner surface 150 is configured to match and slide along a tapered outer surface 152 formed by conical portion 138 of mandrel 120. Axial and radial translation of brake pads 134 are guided by tapered inner surface 150 of pads 134 and tapered outer surface 152 of mandrel 120. As illustrated in FIGS. 3A and 3B, pads 134 may also be fixed in the circumferential direction by a number of tongues 154 configured to cooperate with corresponding grooves (not shown) in pads 134. Tongues 154 protrude radially outward from tapered outer surface of mandrel 120 and are distributed at different angularly disposed, circumferential positions around a longitudinal axis of packer 100. The angularly disposed, circumferential positions of tongues 154 are in general alignment with the corresponding positions of brake mechanisms 130.

For each brake mechanism 130, as first disk 112 moves axially toward second disk 114, expansion boot 116 drives brake plate 136 axially toward second disk 114. Brake plate 136 and linkage 132 drive brake pad 134 toward expansion boot 118. As brake pad 134 moves axially toward expansion boot 118, pad 134 is also drive radially outward by the interaction between tapered inner surface 150 of pad 134 and tapered outer surface 152 of conical portion 138 of mandrel 120. To accommodate the radially changing position of brake pad 134 and the radially fixed position of brake plate 136, linkage 132 pivots relative to pad 134 and brake plate 136 as brake mechanism 130 is driven axially toward expansion boot 118.

As tapered inner surface 150 of pad 134 slides along tapered outer surface 152 of mandrel 120 to drive pad 134 radially outward, brake pad 134 is pushed radially outward into engagement with the inner surface of pipeline 128. The outer surface of brake pad 134 includes a saw-tooth profile defined by a series of circumferentially extending ridges, which are configured to engage the inner surface of pipeline 128 without slipping. In many examples, the ridges will not be symmetrical, but will be configured particularly to prevent movement in the direction toward end cap 106 (i.e., away from the likely location of water influx due to a wet buckle). In one example, pad 134 is manufactured from steel and, in some cases, can include carbide buttons that form the saw-tooth profile of pad 134.

Packer 100 can be actuated from the pipelay vessel on the surface of the sea in the event of a wet buckle in a submerged portion of pipeline 128, e.g., in the sag bend of the “S” curve formed by the suspended span of pipeline 128 as it descends to the sea floor. Packer 100 can include a sensor system that detects the invasion of water into the inner diameter of pipeline 128. In another example, the sensor system can be associated with a separate component and be communicatively coupled to packer 100. In one example, the sensor system includes a water sensor including two spaced electrodes arranged within pipeline 128 such that water invading the pipeline would complete an electrical circuit of the sensor. In another example, a pressure sensor could be used to detect the invasion of water into the inner diameter of pipeline 118.

The sensor system communicatively coupled to packer 100 can provide a signal directly to control electronics included in actuator 129 or can transmit signals to a surface system, which, in turn, transmits control signals to actuator 129 via supply line 131. In the event water invasion is detected, actuator 129 causes the distal end of shaft 148 to move axially closer to housing 146. As the distal end of shaft 148 changes axial position with respect to housing 146, first disk 112 is drawn axially toward second disk 114, which functions to axially compress and radially expand expansion boots 116 and 118. In the radially expanded state illustrated in FIG. 3B, expansion boots 116 and 118 are configured to substantially seal pipeline 128 and thereby arrest or mitigate the wet buckle in pipeline 128.

Actuator 129 also deploys brake assembly 122 to prevent or substantially inhibit movement of packer 100 within pipeline 128. For example, actuator 129 causes the distal end of shaft 148 to move axially closer to housing 146. As the distal end of shaft 148 changes axial position with respect to housing 146, first disk 112 drives brake mechanisms 130 toward expansion boot 118 and second disk 114. Brake plate 136 and linkages 132 drive tapered inner surface 150 of pads 134 along tapered outer surface 152 of mandrel 120, which pushes brake pads 134 radially outward into engagement with the inner surface of pipeline 128 to prevent or inhibit packer 100 from moving within the pipeline.

Although it is not illustrated in FIGS. 3A and 3B, packer 100 can include a locking mechanism that is configured to lock brake assembly 122 once it has been engaged. In one example, the locking mechanism includes a ratchet mechanism including one or more spring loaded pawls connected to brake plate 136 and ratchet teeth inscribed in the outer surface of cylindrical portion 140 of mandrel 120. The ratchet mechanism can be configured to allow first disk 112, expansion boot 116, and brake assembly 122 to move toward second disk 114, while preventing the components from moving axially away from second disk 114 after brake assembly 122 has been engaged. An example ratchet mechanism that could be configured for use with packer 100 is disclosed and described in described in U.S. application Ser. No. ______ (Atty. Docket No. 1880.517US1), filed Jul. ______, 2013 and entitled “METHODS AND APPARATUS FOR ARRESTING FAILURES IN SUBMERGED PIPELINES,” the entire contents of which are incorporated herein by reference.

Packer 100 is configured such that in the unengaged state illustrated in FIG. 3A the outer boundaries of packer 100 are offset from the inner surface of pipeline 128. The offset distance between packer 100 and the inner surface of pipeline 128 may differ at different points along the axial length of packer 100. For example, offset 162 between expansion boots 116 and 118 and the inner surface of the pipeline 128 is different than offset 164 between brake pads 134 and the inner surface of pipeline 128. In the example of packer 100 illustrated in FIG. 3A, offset 162 and offset 164 are approximately equal. In one example, packer 100 is designed such that offset 162 and/or offset 164 are less than or equal to approximately ⅛ inch. However, in other examples, offsets 162 and 164 can be larger or smaller depending on the clearance between packer 100 and pipeline 128 necessary to allow packer 100 to be deployed through pipeline 128 and the amount of radial expansion of expansion boots 116 and 118 and brake pads 134 that is provided when actuator 129 moves moving mandrels 112 and 114 relative to stationary mandrel 120.

Although particular offset distances are described with reference to example packer 100, a packer in accordance with this disclosure will be constructed with a desired dimensional relationship with the dimensions of the pipeline in which the device is to be used. In one example configuration, a radial clearance of approximately ⅛ inch will separate the sealing element of the packer and the pipeline inner surface and a radial clearance of approximately ¼ inch will separate the braking element of the packer and the pipeline inner surface. However, as will be apparent to persons skilled in the art, difference radial dimensions may be used for any size pipe, and in some cases such dimensions may be determined by other factors, such as the designed radius of bends the pipeline will experience while being installed on the sea floor, and/or the intended characteristic of the internal welds used to join the pipeline sections.

In some cases, it may be desirable to configured packer 100 such that offset 162 between expansion boots 116 and 118 and the inner surface of the pipeline 128 is as small as possible while still allowing packer 100 to be deployed downpipe within pipeline 128. In the example of FIG. 3A, the outer peripheries of end caps 104 and 106, bearings 108 and 110, first and second disks 112 and 114, and expansion boots 116 and 118 are configured to fit closely with the inner surface of pipeline 128 even when packer 100 is in an unengaged state. In practice, there may be a delay between the occurrence of a wet buckle to pipeline 128 and the resulting detection of the invasion of water caused by the wet buckle (depending in part on the location of a water sensor, if used), and activation of actuator 129 to cause expansion boots 116 and 118 and brake assembly 122 to engage the inner surface of pipeline 128. During the delay in actuation of packer 100 some water may pass through packer 100. Reducing offset 162 between expansion boots 116 and 118 (as well as reducing the offset between other components of packer 100) and the inner surface of the pipeline 128 will reduce the amount of water that floods pipeline 128 before packer 100 is engaged and the boots substantially seal the pipeline.

As is illustrated in FIG. 3A, end caps 104 and 106, bearings 108 and 110, and mandrel 120 are hollow components. It may be desirable to design the components of packer 100 and other wet buckle packers in accordance with this disclosure as such in order to reduce the weight of the device. Packer 100 may be employed in relatively large pipelines. In one example, pipeline 128 has an inner diameter that is approximately equal to 40 inches. The large size of pipeline 128 necessitates a relatively large packer to seal the inner diameter of the pipeline. As such, in one example, packer 100 may weigh on the order of approximately 10,000 pounds. In such situations, removing as much material from end caps 104 and 106, bearings 108 and 110, and mandrel 120, and other components of packer 100 can have a significant impact on the weight of the device.

The overall weight of packer 100 also affects the amount of load on hoist line 112 and, as such, the amount of work required by the hoist machine operating hoist line 112. As such, reducing the weight of packer 100 can also reduce the cost and complexity of deploying packer 100 via hoist line 112.

The forces encountered by packer 100 in the event of a wet buckle of pipeline 128 may be significant. For example, at a relatively shallow depth of approximately 1500 feet below sea level, the pressures generated by a wet buckle can reach approximately 660 pounds per square inch (psi). At a depth of approximately 12,000 feet, the pressures generated by a wet buckle can reach approximately 5280 psi. In view of the range of forces potentially encountered by wet buckle packer 100, the wall thicknesses of the components of packer 100 may need to be adjusted to withstand large forces/pressures.

It is also noted that the forces encountered by different portions of packer 100 may differ significantly. For example, portions of packer 100 may be partially or substantially pressure balanced because water introduced into pipeline 128 is allowed to enter parts of packer 100. In such situations, the pressure of the water is balanced on particular portions of packer 100. For example, water may be allowed to enter portions of packer 100 such that the pressure is balanced on either side of a wall of one or more of end caps 104 and 106, bearings 108 and 110, and mandrel 120. For example, a seal between shaft 148 and first disk 112 and sealing the fastener apertures in first disk 112 may allow pressure balance of all components of packer 100 except first disk 112. Additionally, flow ports can be manufactured into end cap 104 and bearing 108 to allow rapid pressure balancing. Pressure balancing can be achieved via atmospheric air pressure, as well as water pressure. In some examples, therefore, packer 100 may be designed to allow pressure balancing of some portions of the device such that the wall thicknesses of different portions of end caps 104 and 106, bearings 108 and 110, and mandrel 120, and other components of packer 100 may differ significantly depending on the amount of pressure/force encountered in the event of a wet buckle.

In order to engage packer 100 including radially expanding expansion boots 116 and 118 and setting brake assembly 122, actuator 129 is configured to generate a range of setting forces. In one example, actuator 129 is configured to generate a setting force approximately equal to 60,000 pounds to substantially seal pipeline 128 with expansion boots 116 and 118 and prevent or inhibit movement of packer 100 with brake assembly 122. In other examples, actuator 129 is configured to generate a setting force that is less or greater than 60,000 pounds. For example, in a smaller diameter pipe approximately equal to 7 inches, actuator 129 is configured to generate a setting force approximately equal to 12,000 pounds.

A variety of materials can be used to fabricate the components of packer 100 including, e.g., metals, plastics, elastomers, and composites. For example, first and second disks 112 and 114, bearings 108 and 110, brake pads 134 and mandrel 120 can be fabricated from a variety of different types of steel or aluminum. Expansion boots 116 and 118 can be fabricated from a variety of elastomeric materials including rubber. Additionally, end caps 104 and 106 can be fabricated from a variety of elastomers. In the example of FIGS. 3A and 3B, end caps 104 and 106 are illustrated as fabricated from an elastomer. In such cases, end cap 104 may need to be structurally reinforced to withstand the pressures caused by the invasion of water into pipeline 118. As such, packer 100 includes scaffold cone 156, which is configured to limit the amount end cap 104 can collapse inward in the event of a wet buckle. Scaffold cone 156 can be fabricated from a strong, rigid material such as steel or aluminum.

In one example, end caps 104 and 106, expansion boots 116 and 118, and/or brake pads 134 are fabricated from a nitrile rubber. At the sea floor, packer 100 may encounter temperatures as low as 32 degrees Fahrenheit (0 degrees Celsius). As such, end caps 104 and 106, expansion boots 116 and 118, and/or brake pads 134 may need to be fabricated from elastomers that can withstand relatively low temperatures without significantly affecting the material properties of the components. For example, expansion boots 116 and 118 may need to be fabricated from elastomers that can withstand relatively low temperatures without causing the expansion boots to become too hard, stiff and/or brittle such that the boots are incapable of sufficiently sealing the inner diameter of pipeline 128. The components of packer 100 can be fabricated using a variety of techniques including, e.g., machining, injection molding, casting, and other appropriate techniques for manufacturing such parts.

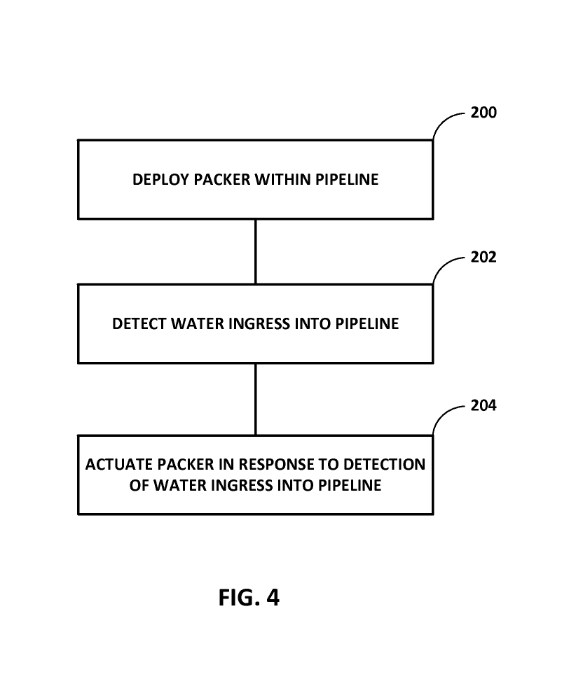

FIG. 4 is a flowchart depicting an example method of arresting a failure of a submerged pipeline. The method includes deploying a packer apparatus within the pipeline (200), detecting water ingress into the pipeline (202), and actuating the packer apparatus in response to the detection of the water ingress into the pipeline (204). In one example, the packer includes a first disk and a second disk offset from and axially aligned with the first disk. A mandrel, elastomeric expansion boot, and brake are disposed between and axially aligned with the first and second disks. The mandrel includes a tapered outer surface and the brake includes a tapered inner surface abutting the tapered inner surface of the mandrel. The first disk is configured to move axially toward the second disk from a first position to a second position. In the second position, the first disk causes: the expansion boot to compress axially and expand radially into engagement with an inner surface of the pipeline; and the tapered inner surface of the brake to move axially along the tapered outer surface of the stationary mandrel to cause the brake to move radially outward into engagement with the inner surface of the pipeline.

The packer apparatus can be deployed into the pipeline via a hoist line connected to a hoist machine on a pipelay vessel. Detection of water ingress into the pipeline can include sensing water invasion into the inner diameter of the pipeline with a sensor included in or separate from the packer apparatus. In one example, the packer can include a sensor system that detects the invasion of water into the inner diameter of the pipeline. The sensor system communicatively coupled to the packer can provide a signal directly to control electronics included in an actuator of the packer or can transmit signals to a surface system, which, in turn, transmits control signals to the actuator via a supply line. In the event water invasion is detected, the actuator of the packer can trigger actuation of the device.

Actuating the packer apparatus can include transmitting signals from the pipelay vessel on the surface to the packer via the supply line connected to the actuator of the packer. The actuator can be configured to move the first disk axially toward the second disk from a first position to a second position. In the second position, the first disk causes: the expansion boot to compress axially and expand radially into engagement with an inner surface of the pipeline; and the tapered inner surface of the brake to move axially along the tapered outer surface of the stationary mandrel to cause the brake to move radially outward into engagement with the inner surface of the pipeline.

The expansion boot of the packer apparatus can be a first elastomeric expansion boot disposed between the first disk and a first end of the brake. The packer apparatus can also include a second elastomeric expansion boot disposed between the second disk and a second end of the brake. In the second position, the second expansion boot is compressed axially between the second end of the brake and the second disk and is expanded radially into engagement with an inner surface of the pipeline.

As described above, methods of arresting failures of a submerged pipeline can include deploying multiple packers within the submerged pipeline. In one example, the packers are deployed on either side (e.g. one closer to the surface and one farther from the surface and closer to the sea floor) of the location of the wet buckle (or other failure). In such examples, both packers can be actuated to seal the region of the pipeline between the packers and including the location of the failure.

Various examples have been described. These and other examples are within the scope of the following claims.

I claim:

1. A packer apparatus configured to be arranged within and arrest a failure of a submerged pipeline, the packer apparatus comprising:
a first disk;
a second disk offset from and axially aligned with the first disk;
a mandrel, an elastomeric expansion boot, and a brake disposed between and axially aligned with the first and second disks, wherein the mandrel comprises a tapered outer surface and the brake comprises a tapered inner surface abutting the tapered outer surface of the mandrel;
wherein the first disk is configured to move axially toward the second disk from a first position to a second position, and
wherein, in the second position, the first disk causes:
the expansion boot to compress axially and expand radially into engagement with an inner surface of the pipeline; and
the tapered inner surface of the brake to move axially along the tapered outer surface of the mandrel to cause the brake to move radially outward into engagement with the inner surface of the pipeline.

2. The apparatus of claim 1, wherein the expansion boot is a first elastomeric expansion boot disposed between the first disk and a first end of the brake, and further comprising a second elastomeric expansion boot disposed between the second disk and a second end of the brake, wherein, in the second position, the second expansion boot is compressed axially between the second end of the brake and the second disk and is expanded radially into engagement with an inner surface of the pipeline.

3. The apparatus of claim 1, further comprising an actuator configured to cause the first disk to move axially toward the second disk from the first position to the second position.

4. The apparatus of claim 1, wherein the expansion boot is in a radially unexpanded state and the brake is unengaged with the inner surface of the pipeline when the first disk is in the first position.

5. The apparatus of claim 1, wherein the mandrel comprises a conical or frustoconical portion defining the tapered outer surface and a cylindrical portion comprising a bore.

6. The apparatus of claim 5, wherein the brake comprises:
a plate comprising a bore in which the cylindrical portion is configured to be received;
a plurality of linkages;
a plurality of pads, each of which comprises a tapered inner surface abutting the tapered outer surface of the mandrel,
wherein each linkage is pivotally connected to the plate and to one of the pads, and wherein the linkages and the pads are distributed at different angularly disposed, circumferential positions around a longitudinal axis of the packer apparatus.

7. The apparatus of claim 6, wherein each of the pads comprises a curved outer surface that substantially matches a curved inner surface of the pipeline.

8. The apparatus of claim 7, wherein the curved outer surface of each of the pads comprises a saw-tooth profile defined by a series of circumferentially extending ridges.

9. The apparatus of claim 5, further comprising an actuator configured to cause the first disk to move axially toward the second disk from the first position to the second position, wherein the actuator is arranged in the bore of the cylindrical portion of the mandrel and is connected to the mandrel and to the first disk.

10. The apparatus of claim 8, wherein the actuator comprises at least one of a pneumatic, hydraulic, electrical, electromechanical, and electromagnetic actuator.

11. The apparatus of claim 1, further comprising at least one bearing comprising a plurality of wheels rotatably connected to the bearing, wherein the wheels are distributed at different angularly disposed, circumferential positions around a longitudinal axis of the packer apparatus.

12. The apparatus of claim 1, further comprising a sensor configured to detect ingress of water into the pipeline.

13. The apparatus of claim 1, further comprising:
a first end cap defining a first end of the packer apparatus and comprising a conical or frustoconical shape; and
a second end cap defining a second end of the packer apparatus and comprising a conical or frustoconical shape.

14. A system for arresting a failure of a submerged pipeline, the system comprising:
a hoist machine;
a packer apparatus configured to be arranged within the submerged pipeline, wherein the packer apparatus comprises:
a first disk;
a second disk offset from and axially aligned with the first disk;
a mandrel, an elastomeric expansion boot, and a brake disposed between and axially aligned with the first and second disks, wherein the mandrel comprises a tapered outer surface and the brake comprises a tapered inner surface abutting the tapered outer surface of the mandrel;
wherein the first disk is configured to move axially toward the second disk from a first position to a second position, and
wherein, in the second position, the first disk causes:
the expansion boot to compress axially and expand radially into engagement with an inner surface of the pipeline; and
the tapered inner surface of the brake to move axially along the tapered outer surface of the mandrel to cause the brake to move radially outward into engagement with the inner surface of the pipeline;
a hoist line comprising a first end operatively connected to the hoist machine and second end connected to the packer apparatus.

15. The system of claim 14, wherein the expansion boot is a first elastomeric expansion boot disposed between the first disk and a first end of the break, and further comprising a second elastomeric expansion boot disposed between the second disk and a second end of the brake, wherein, in the second position, the second expansion boot is compressed axially between the second end of the brake and the second disk and is expanded radially into engagement with an inner surface of the pipeline.

16. The system of claim 14, further comprising an actuator configured to cause the first disk to move axially toward the second disk from the first position to the second position.

17. The system of claim 14, wherein the expansion boot is in a radially unexpanded state and the brake is unengaged with the inner surface of the pipeline when the first disk is in the first position.

18. The system of claim 14, wherein the mandrel comprises a conical portion defining the tapered outer surface and a cylindrical portion comprising a bore.

19. The system of claim 18, wherein the brake comprises:
a plate comprising a bore in which the cylindrical portion is configured to be received;
a plurality of linkages;
a plurality of pads, each of which comprises a tapered inner surface abutting the tapered outer surface of the mandrel,
wherein each linkage is pivotally connected to the plate and to one of the pads, and wherein the linkages and the pads are distributed at different angularly disposed, circumferential positions around a longitudinal axis of the packer apparatus.

20. The system of claim 19, wherein each of the pads comprises a curved outer surface that substantially matches a curved inner surface of the pipeline.

21. The system of claim 20, wherein the curved outer surface of each of the pads comprises a saw-tooth profile defined by a series of circumferentially extending ridges.

22. The system of claim 19, further comprising an actuator configured to cause the first disk to move axially toward the second disk from the first position to the second position, wherein the actuator is arranged in the bore of the cylindrical portion of the mandrel and is connected to the mandrel and to the first disk.

23. The system of claim 22, wherein the actuator comprises at least one of a pneumatic, hydraulic, electrical, electromechanical, and electromagnetic actuator.

24. The system of claim 14, further comprising at least one bearing comprising a plurality of wheels rotatably connected to the bearing, wherein the wheels are distributed at different angularly disposed, circumferential positions around a longitudinal axis of the packer apparatus.

25. The system of claim 14, further comprising a sensor configured to detect ingress of water into the pipeline.

26. The system of claim 14, further comprising:
a first end cap defining a first end of the packer apparatus and comprising a conical or frustoconical shape; and
a second end cap defining a second end of the packer apparatus and comprising a conical or frustoconical shape.

27. A system for arresting a failure of a submerged pipeline, the system comprising:
a first packer apparatus configured to be disposed at a first position within the pipeline; and
a second packer apparatus configured to be disposed at a second position within the pipeline,
wherein at least one of the first and the second packer apparatus comprises:
a first disk;
a second disk offset from and axially aligned with the first disk;
a mandrel, an elastomeric expansion boot, and a brake disposed between and axially aligned with the first and second disks, wherein the mandrel comprises a tapered outer surface and the brake comprises a tapered inner surface abutting the tapered outer surface of the mandrel;
wherein the first disk is configured to move axially toward the second disk from a first position to a second position, and
wherein, in the second position, the first disk causes:
the expansion boot to compress axially and expand radially into engagement with an inner surface of the pipeline; and
the tapered inner surface of the brake to move axially along the tapered outer surface of the mandrel to cause the brake to move radially outward into engagement with the inner surface of the pipeline.

28. A method of arresting a failure of a submerged pipeline,
the method comprising:
deploying a packer apparatus within the pipeline, wherein the packer apparatus comprises:
a first disk;
a second disk offset from and axially with the first disk;
a mandrel, an elastomeric expansion boot, and a brake disposed between and axially aligned with the first and second disks, wherein the mandrel comprises a tapered outer surface and the brake comprises a tapered inner surface abutting the tapered inner surface of the mandrel;
detecting ingress of water into the pipeline;
actuating the packer apparatus, wherein actuating the packer apparatus comprises:
moving the first disk axially toward the second disk from a first position to a second position, and
wherein, in the second position, the first disk causes:
the expansion boot to compress axially and expand radially into engagement with an inner surface of the pipeline; and
the tapered inner surface of the brake to move axially along the tapered outer surface of the mandrel to cause the brake to move radially outward into engagement with the inner surface of the pipeline.
